(19) United States
(12) Patent Application Publication
(10) Pub. No.: US 2018/0178448 A1
(43) Pub. Date: Jun. 28, 2018

(54) METHOD OF PRODUCING THREE-DIMENSIONAL OBJECT, POSITION ADJUSTMENT METHOD, AND THREE-DIMENSIONAL FABRICATING APPARATUS

(71) Applicant: Yoichi KAKUTA, Kanagawa (JP)

(72) Inventor: Yoichi KAKUTA, Kanagawa (JP)

(21) Appl. No.: 15/850,026

(22) Filed: Dec. 21, 2017

(30) Foreign Application Priority Data
Dec. 26, 2016 (JP) 2016-251980

(51) Int. Cl. B29C 64/209; B33Y 10/00; B33Y 30/00; B29C 64/10; B29C 64/393

(52) U.S. Cl. CPC B29C 64/209; B33Y 10/00; B29C 64/393; B29C 64/10; B33Y 30/00

(57) ABSTRACT

A method of producing a three-dimensional object includes adjusting relative positions of a material ejector held on a holder and a stage and fabricating a three-dimensional object on the stage. The fabricating includes forming layers of a material ejected from the ejector on the stage. The adjusting includes relatively moving the holder and the stage in a contact-and-separation direction with the ejector displaceable held relative to the holder, to contact the ejector and the stage; positioning the ejector with respect to the holder in a state in which the ejector is in contact with the stage; and relatively moving the holder and the stage in the contact-and-separation direction, with reference to positions of the holder and the stage in the contact-and-separation direction in the state in which the ejector is in contact with the stage, so that the ejector is away from the stage at a predetermined separation distance.

### CROSS-REFERENCE TO RELATED APPLICATION

This patent application is based on and claims priority pursuant to 35 U.S.C. § 119(a) to Japanese Patent Application No. 2016-251980, filed on Dec. 26, 2016, in the Japan Patent Office, the entire disclosure of which is hereby incorporated by reference herein.

### BACKGROUND

### Technical Field

Aspects of the present disclosure relate to a method for producing a three-dimensional object, a position adjustment method, and a three-dimensional fabricating apparatus.

### Related Art

A three-dimensional fabricating apparatus is known that includes a material ejector, which is held on a holder, and a stage that are relatively movable in directions to contact and separate from each other. A method of producing a three-dimensional object is known in which a three-dimensional object is fabricated on the stage with a material ejected from the material ejector in the three-dimensional fabricating apparatus.

### SUMMARY

In an aspect of the present disclosure, there is provided a method of producing a three-dimensional object that includes adjusting relative positions of a material ejector held on a holder and a stage and fabricating a three-dimensional object on the stage. The fabricating includes relatively moving the material ejector and the stage in a contact-and-separation direction to contact and separate from each other, and forming layers of a material ejected from the material ejector on the stage. The adjusting includes first relatively moving the holder and the stage in the contact-and-separation direction with the material ejector being held to be displaceable in the contact-and-separation direction relative to the holder, to contact the material ejector and the stage; positioning the material ejector with respect to the holder in a state in which the material ejector is in contact with the stage; and second relatively moving the holder and the stage in the contact-and-separation direction, with reference to positions of the holder and the stage in the contact-and-separation direction in the state in which the material ejector is in contact with the stage, so that the material ejector is away from the stage at a predetermined separation distance.

In another aspect of the present disclosure, there is provided a method of adjusting relative positions of a material ejector held on a holder and a stage in a three-dimensional fabricating apparatus that relatively moves the material ejector and the stage in a contact-and-separation direction to contact and separate from each other and forms layers of a material ejected from the material ejector on the stage. The method includes first relatively moving the holder and the stage in the contact-and-separation direction with the material ejector being held to be displaceable in the contact-and-separation direction relative to the holder, to contact the material ejector and the stage; positioning the material ejector with respect to the holder in a state in which the material ejector is in contact with the stage; and second relatively moving the holder and the stage in the contact-and-separation direction, with reference to positions of the holder and the stage in the contact-and-separation direction in the state in which the material ejector is in contact with the stage, so that the material ejector is away from the stage at a predetermined separation distance.

In another aspect of the present disclosure, there is provided a three-dimensional fabricating apparatus that includes a holder, a stage, a material ejector, a moving assembly, a positioner, and a controller. The material ejector is held on the holder, to eject a material to form layers of the material on the stage. The moving assembly relatively moves the holder and the stage in a contact-and-separation direction to contact the material ejector and the stage. The positioner switches a displaceable state in which the material ejector is displaceable in the contact-and-separation direction relative to the holder and a positioned state in which the material ejector is positioned relative to the holder. The controller controls the positioner to switch to the displaceable state and controls the moving assembly to relatively move the holder and the stage in the contact-and-separation direction to contact the material ejector and the stage. The controller controls the positioner to switch to the positioned state in a state in which the material ejector is in contact with the stage, and controls the moving assembly to relatively move the holder and the stage in the contact-and-separation direction so that the material ejector is away from the stage at a predetermined separation distance.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a block diagram of a schematic configuration of a three-dimensional fabricating apparatus according to an embodiment of the present disclosure;

FIG. 2 is an illustration of the three-dimensional fabricating apparatus;

FIG. 3 is an outer perspective view of a chamber disposed in the three-dimensional fabricating apparatus;

FIG. 4 is a schematic perspective view of the three-dimensional fabricating apparatus in a state in which a front portion of the three-dimensional fabricating apparatus is cut and removed;

FIG. 5 is a block diagram of control of the three-dimensional fabricating apparatus;

FIG. 6 is a flowchart of a flow of a preheating process and a fabrication process in the three-dimensional fabricating apparatus;

FIG. 7 is a cross-sectional view of a configuration of a fabrication head in the three-dimensional fabricating apparatus;

FIG. 8 is a flowchart of a flow of Initialization process according to an embodiment of the present disclosure;

FIG. 9 is an illustration of positions of nozzle units and stage in a Z-axis direction at time points during the initialization process in an example;

FIG. 10 is an illustration of positions of the nozzle units and the stage in the Z-axis direction at time points during the initialization process in another example;

FIG. 11 is a flowchart of a flow of the initialization process in variation 1;

FIG. 12 is an illustration of an example of positions of the nozzle units and the stage in the Z-axis direction at time points during the initialization process in variation 1;

FIG. 13 is a cross-sectional view of a configuration of the fabrication head in variation 2;

FIG. 14 is a flowchart of a flow of the initialization process in variation 2; and

FIG. 15 is an illustration of positions of the nozzle units and the stage in the Z-axis direction at time points during the initialization process in variation 2.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Hereinafter, embodiments of the present disclosure are described with reference to the drawings.

Overall Description

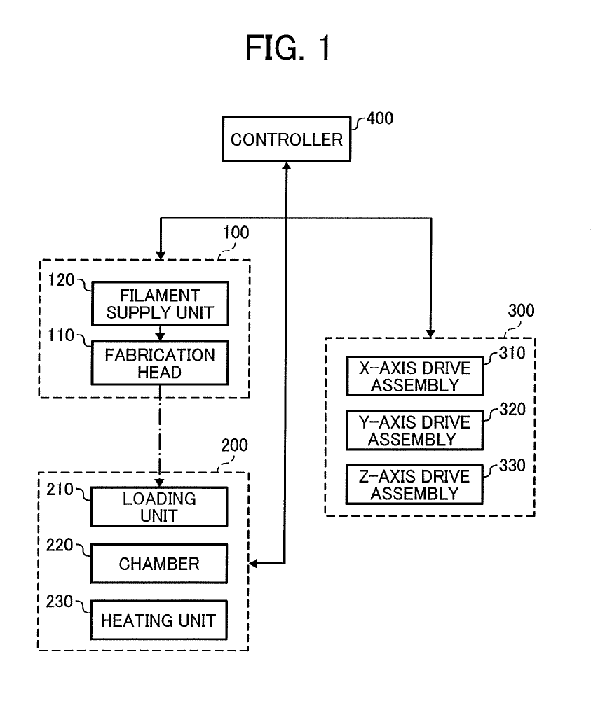

FIG. 1 is a block diagram of a schematic configuration of a three-dimensional fabricating apparatus 1 according to an embodiment of the present disclosure. The three-dimensional fabricating apparatus 1 according to the present embodiment mainly includes a material supply unit 100, a three-dimensional fabricating unit 200, a driving unit 300, and a controller 400. In the three-dimensional fabricating apparatus 1, the driving unit 300 drives the material supply unit 100 and the three-dimensional fabricating unit 200 under the control of the controller 400. Thus, the three-dimensional fabricating unit 200 fabricates a three-dimensional object (three-dimensional fabrication object) with a material supplied from the material supply unit 100.

Material Supply Unit

The material supply unit 100 includes at least a fabrication head 110 to extrude a material and a filament supply unit 120 to supply filaments as fabrication material to the fabrication head 110. The filament is an elongated wire-shaped solid, is set in the three-dimensional fabricating apparatus 1 in a wound state, and is supplied to nozzles 111 of the fabrication head 110 with the filament supply unit 120. The filaments supplied with the filament supply unit 120 are heated and melted by the fabrication head 110, and the filaments in molten state are extruded from the nozzles 111 by inserting filaments in solid state from a rear side of the nozzles 111.

Note that the material extruded from the nozzles 111 on the fabrication head 110 is not limited to a fabrication material constituting a three-dimensional object and may be a support material not constituting a three-dimensional object. The support material is made of a material different from a fabrication material (filament) constituting the three-dimensional object, and is finally removed from the three-dimensional object made of the filaments. The support material is also heated and melted with the fabrication head 110. The support material in molten state is extruded from the nozzles 111 by inserting filaments of the support material in solid state from the rear side.

Three-Dimensional Fabricating Unit

The three-dimensional fabricating unit 200 includes at least a loading unit 210, a chamber 220, and a heating unit 230. The interior of the chamber 220 in the three-dimensional fabricating unit 200 is a processing space to fabricate a three-dimensional object. The filaments in the molten state extruded from the fabrication head 110 in the material supply unit 100 are supplied onto a stage 211 of the loading unit 210 inside the chamber 220 heated by the heating unit 230 and are sequentially laminated in layers.

Driving Unit

The driving unit 300 includes at least an X-axis drive assembly 310, a Y-axis drive assembly 320, and a Z-axis drive assembly 330 as drivers. The driving unit 300 relatively moves the fabrication head 110 of the material supply unit 100 and the stage 211 of the loading unit 210 in the three-dimensional fabricating unit 200 with the X-axis drive assembly 310, the Y-axis drive assembly 320, and the Z-axis drive assembly 330 as drivers. With such a configuration, the filaments extruded from the fabrication head 110 of the material supply unit 100 are supplied onto target positions on the stage 211.

Other Functional Units

The three-dimensional fabricating apparatus 1 according to the present embodiment includes the material supply unit 100, the three-dimensional fabricating unit 200, the driving unit 300, and the controller 400, as described above. In addition, other functional units may be added as needed.

Details of Three-Dimensional Fabricating Apparatus

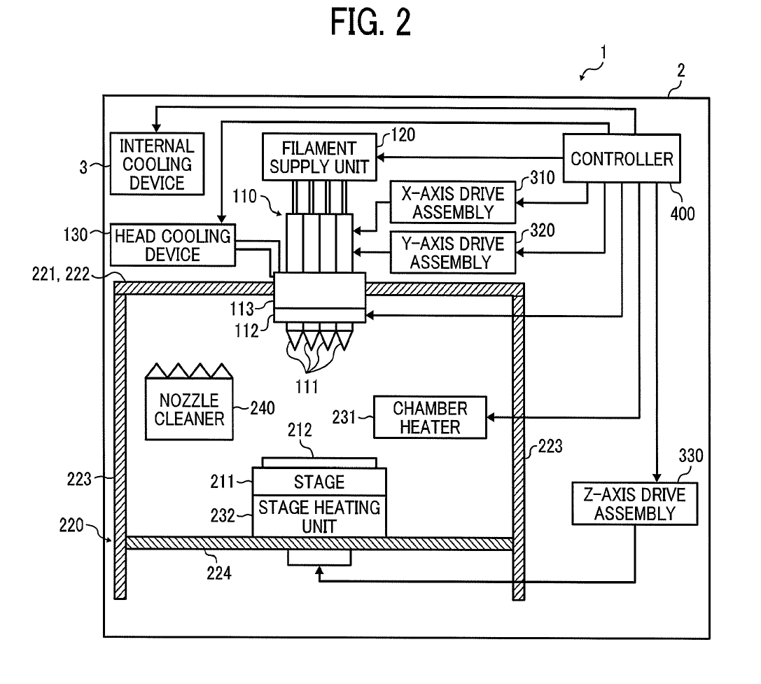

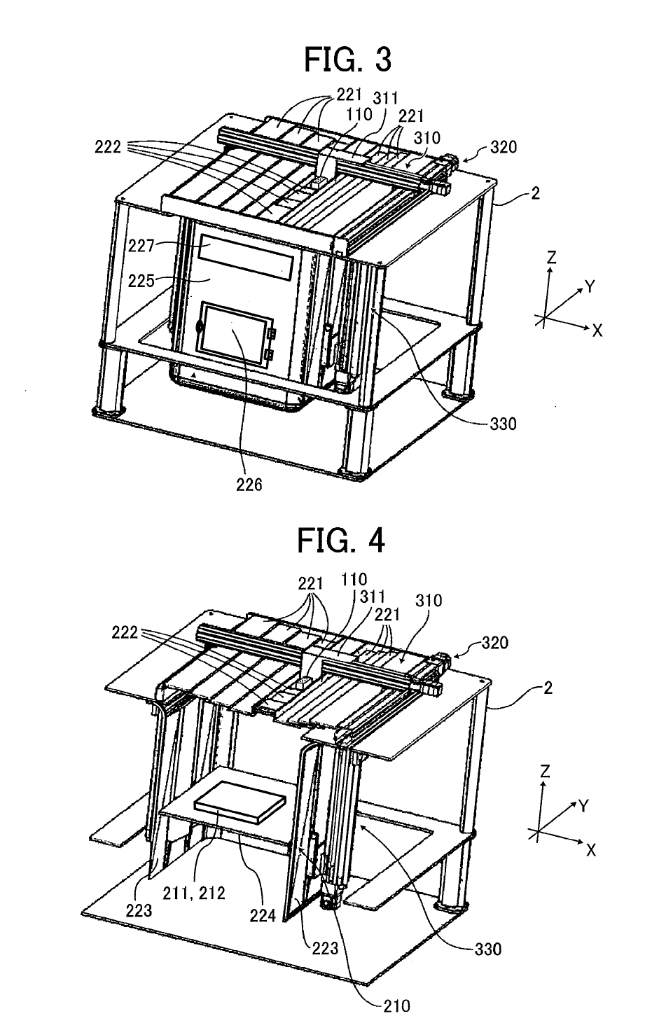

Next, a description is further given of the three-dimensional fabricating apparatus 1 according to the present embodiment. FIG. 2 is a schematic view of the three-dimensional fabricating apparatus 1 according to the present embodiment. FIG. 3 is an outer perspective view of a chamber disposed in the three-dimensional fabricating apparatus 1 according to the present embodiment. FIG. 4 is a perspective view of the three-dimensional fabricating apparatus 1 according to the present embodiment in a state in which a front portion of the three-dimensional fabricating apparatus 1 is cut and removed for illustration.

The three-dimensional fabricating apparatus 1 includes a three-dimensional fabricating chamber 220 (hereinafter, chamber 220) in a body frame 2. The stage 211 of the loading unit 210 is disposed inside the chamber 220. In the present embodiment, a fabrication plate 212 is held on the stage 211, and a three-dimensional object is fabricated on the fabrication plate 212.

Most or all of walls surrounding the processing space in the chamber 220 are insulation walls having insulating function. For example, a ceiling wall of the chamber 220 is a heat insulation wall including a plurality of slide insulators 221 and 222 as described below. Further, opposed side walls 223 of the chamber 220, that is, both walls in a left-and-right direction of the apparatus (a left-and-right direction in FIGS. 3 and 4, in other words, an X-axis direction) are heat insulation walls having a structure in which heat insulating material that includes, e.g., glass wool is interposed between an inner plate and an outer plate. Further, a bottom wall 224 of the chamber 220 is also a heat insulation wall having the structure in which heat insulating material that includes, e.g., glass wool is interposed between an inner plate and an outer plate. Further, a rear wall and a front wall 225 of the chamber 220 are also heat insulation walls having the structure in which heat insulating material that includes, e.g., glass wool is interposed between an inner plate and an outer plate.

In the present embodiment, a swing door 226 is disposed in the front wall 225 of the chamber 220, as illustrated in FIG. 3. The swing door 226 configures the heat insulation wall, similarly to the front wall 225, and has a configuration that exhibits a sufficient insulating function. Further, a window 227 is disposed in the front wall 225 of the chamber 220, as illustrated in FIG. 3. The window 227 has a double glass structure that interposes an air layer, and configures the heat insulation wall, similarly to the front wall 225.

The fabrication head 110 of the material supply unit 100 is disposed above the stage 211 in the chamber 220. The fabrication head 110 has the nozzles 111 to extrude filaments downward. In the present embodiment, the four nozzles 111 are disposed on the fabrication head 110. However, the number of the nozzles 111 may be any other suitable number. The fabrication head 110 further includes a head heating portion 112 to heat the filaments supplied to the nozzles 111. The fabrication head 110 also includes a head cooling portion 113 to cool a side opposite to the nozzle 111 with respect to the head heating portion 112, that is, an upstream side from the head heating portion 112 in a transfer direction of the filament (hereinafter, may be referred to as filament transfer direction).

The filaments may be different from each other or the same between the nozzles 111. In the present embodiment, filaments supplied from the filament supply unit 120 are melted or softened by heating of the head heating portion 112. By extruding the filaments in molten state from the nozzles 111, layered fabrication structures are sequentially laminated on the fabrication plate 212 on the stage 211 to fabricate a three-dimensional object. Note that, instead of the filaments as fabrication material, a support material not constituting a resultant three-dimensional object may be supplied from the nozzles 111 on the fabrication head 110.

The fabrication head 110 is movably held to the X-axis drive assembly 310 extending in the left-and-right direction (a left-and-right direction, that is, an X-axis direction in FIGS. 3 and 4) of the three-dimensional fabricating apparatus 1 via a connector 311. The fabrication head 110 is movable along a longitudinal direction (the X-axis direction in FIGS. 3 and 4) of the X-axis drive assembly 310. The fabrication head 110 is movable in the left-and-right direction (the X-axis direction) of the three-dimensional fabricating apparatus 1 by a drive force of the X-axis drive assembly 310. Since the fabrication head 110 is heated to high temperature by the head heating portion 112, the connector 311 preferably has low heat conductivity to reduce transmission of heat from the fabrication head 110 to the X-axis drive assembly 310.

Opposed ends of the X-axis drive assembly 310 are movably held to a Y-axis drive assembly 320 extending in a front-and-rear direction (a front-and-rear direction, that is, a Y-axis direction in FIGS. 3 and 4) of the three-dimensional fabricating apparatus 1. The opposed ends of the X-axis drive assembly 310 are slidable along a longitudinal direction (the Y-axis direction in FIGS. 3 and 4) of the Y-axis drive assembly 320. The X-axis drive assembly 310 moves along the Y-axis direction by a drive force of the Y-axis drive assembly 320, thus allowing the fabrication head 110 to move along the Y-axis direction.

In the present embodiment, the bottom wall 224 of the chamber 220 is movably held to the Z-axis drive assembly 330 that is secured to the body frame 2 and extends in an up-and-down direction (an up-and-down direction, that is, a Z-axis direction in FIGS. 3 and 4) of the three-dimensional fabricating apparatus 1. The bottom wall 224 is movable along a longitudinal direction (the Z-axis direction in FIGS. 3 and 4) of the Z-axis drive assembly 330. The bottom wall 224 of the chamber 220 is movable along the up-and-down direction of the three-dimensional fabricating apparatus 1 (the Z-axis direction in FIGS. 3 and 4) by the drive force of the Z-axis drive assembly 330. Since the stage 211 is secured on the bottom wall 224, the stage 211 and fabrication plate 212 held by the stage 211 can be moved in the Z-axis direction by the drive force of the Z-axis drive assembly 330.

In the present embodiment, a chamber heater 231 of the heating unit 230 to heat the interior of the chamber 220 is disposed in the interior (the processing space) of the chamber 220. In the present embodiment, since a three-dimensional object is fabricated by fused deposition modeling (FDM), a fabrication process is preferably performed in a state in which the internal temperature of the chamber 220 is maintained at a target temperature. Accordingly, in the present embodiment, before starting the fabrication process, a preheating process is performed to preliminarily raise the internal temperature of the chamber 220 to the target temperature. In the preheating process, the chamber heater 231 heats the interior of the chamber 220 to raise the internal temperature of the chamber 220 to the target temperature. In the fabrication process, the chamber heater 231 heats the interior of the chamber 220 to maintain the internal temperature of the chamber 220 at the target temperature.

In the present embodiment, the drive target of the X-axis drive assembly 310 and the Y-axis drive assembly 320 is the fabrication head 110, and a portion of the fabrication head 110 (a front end portion of the fabrication head 110 including the nozzles 111) is disposed in the chamber 220. In the present embodiment, even if the fabrication head 110 moves in the X-axis direction, the inside of the chamber 220 is shielded from the outside. For example, on a ceiling wall of the chamber 220, as illustrated in FIG. 3 and FIG. 4, a plurality of X-axis slide insulators 221 longer in the Y-axis direction is arrayed in the X-axis direction. Adjacent ones of the X-axis slide insulators 221 are relatively slidable along the X-axis direction. With such a configuration, even when the fabrication head 110 is moved along the X-axis direction by the X-axis drive assembly 310, the X-axis slide insulators 221 slide along the X-axis direction and an upper area of the processing space of the chamber 220 is constantly covered with the X-axis slide insulators 221.

Likewise, at the ceiling wall of the chamber 220, as illustrated in FIGS. 3 and 4, a plurality of Y-axis slide insulators 222 are arrayed in the Y-axis direction. Adjacent ones of the Y-axis slide insulators 222 are relatively slidable along the Y-axis direction. With such a configuration, even when the fabrication head 110 on the X-axis drive assembly 310 is moved along the Y-axis direction by the Y-axis drive assembly 320, the Y-axis slide insulators 222 slide along the Y-axis direction and the upper area of the processing space in the chamber 220 is constantly covered with the Y-axis slide insulators 222.

A drive target of the Z-axis drive assembly 330 in the present embodiment is the bottom wall 224 of the chamber 220 or the stage 211 (or the fabrication plate 212). In the present embodiment, even if the bottom wall 224 or the stage 211 moves in the Z-axis direction, the inside of the chamber 220 is shielded from the outside.

In the present embodiment, the three-dimensional fabricating apparatus 1 further includes, e.g., an internal cooling device 3 to cool an internal space of the three-dimensional fabricating apparatus 1 outside the chamber 220, a nozzle cleaner 240 to clean the nozzles 111 of the fabrication head 110, and a head cooling device 130 to cool the head cooling portion 113 of the fabrication head 110.

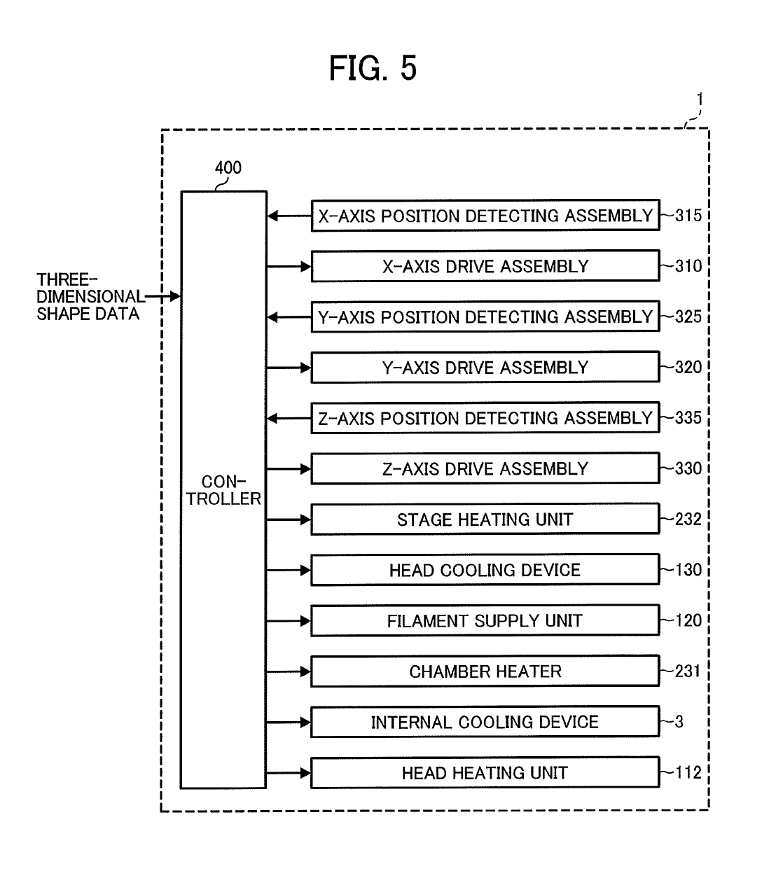

FIG. 5 is a block diagram of control of the three-dimensional fabricating apparatus 1 according to the present embodiment. In the present embodiment, the three-dimensional fabricating apparatus 1 includes an X-axis position detecting assembly 315 to detect the position of the fabrication head 110 in the X-axis direction. Detection results of the X-axis position detecting assembly 315 are transmitted to the controller 400. The controller 400 controls the X-axis drive assembly 310 according to the detection results to move the fabrication head 110 to a target position in the X-axis direction.

In the present embodiment, the three-dimensional fabricating apparatus 1 further includes a Y-axis position detecting assembly 325 to detect the position of the X-axis drive assembly 310 in the Y-axis direction (the position of the fabrication head 110 in the Y-axis direction). Detection results of the Y-axis position detecting assembly 325 are transmitted to the controller 400. The controller 400 controls the Y-axis drive assembly 320 according to the detection results to move the fabrication head 110 on the X-axis drive assembly 310 to a target position in the Y-axis direction.

In the present embodiment, the three-dimensional fabricating apparatus 1 further includes a Z-axis position detecting assembly 335 to detect the position of the fabrication plate 212, which is held on the stage 211, in the Z-axis direction. Detection results of the Z-axis position detecting assembly 335 are transmitted to the controller 400. The controller 400 controls the Z-axis drive assembly 330 according to the detection results to move the fabrication plate 212 on the stage 211 to a target position in the Z-axis direction.

As described above, the controller 400 controls movement of the fabrication head 110 and the stage 211 to set the three-dimensionally relative positions of the fabrication head 110 and the fabrication plate 212 on the stage 211 in the chamber 220 to three-dimensional target positions.

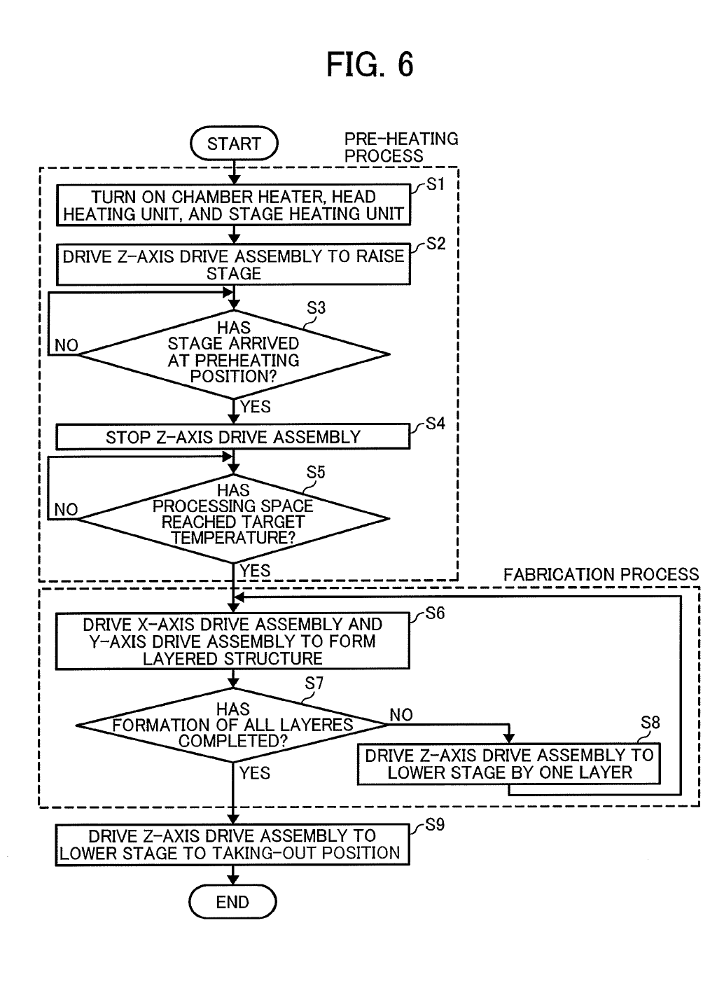

FIG. 6 is a flowchart of a flow of the preheating process and the fabrication process according to the present embodiment. In the present embodiment, when starting fabrication upon an instruction operation of a user, the controller 400 first turns ON electricity to activate the chamber heater 231, the head heating portion 112, and the stage heating unit 232 (S1). Further, the controller 400 controls the Z-axis drive assembly 330 to raise the stage 211 from a predetermined standby position (for example, a lowest point) by the drive force of the Z-axis drive assembly 330 (S2). When the stage 211 has arrived at the preheating position (Yes in S3), the controller 400 stops driving of the Z-axis drive assembly 330 (S4).

When the temperature in the processing space has reached the target temperature (Yes in S5), subsequently, the controller 400 shifts to the fabrication process. Three-dimensional shape data of the three-dimensional object to be fabricated by the three-dimensional fabricating apparatus 1 of the present embodiment is input from an external device such as personal computer data-communicatively connected to the three-dimensional fabricating apparatus 1 in a wired or wireless manner. The controller 400 generates data of a large number of layered fabrication structures decomposed in the up-and-down direction (fabrication slice data) on the basis of the input three-dimensional shape data. The slice data corresponding to each layered fabrication structure corresponds to a layered fabrication structure formed of the filaments extruded from the fabrication head 110 of the three-dimensional fabricating apparatus 1, and the thickness of the layered fabrication structure is appropriately set according to the performance of the three-dimensional fabricating apparatus 1.

In the fabrication process, first, the controller 400 creates the layered fabrication structure of the lowermost layer on a surface of the fabrication plate 212 held on the stage 211 according to the slice data of the lowermost (first) layer (S6). For example, the controller 400 controls the X-axis drive assembly 310 and the Y-axis drive assembly 320 according to the slice data of the lowermost layer (first layer) to extrude the filaments through the nozzles 111 of the fabrication head 110 while sequentially moving tips of the nozzles 111 to target positions (on an X-Y plane). As a result, on the surface of fabrication plate 212 on the stage 211, a layered structure according to the slice data of the lowermost layer (first layer) is formed. Note that the support material that does not configure the three-dimensional object may sometimes be created together. However, description here is omitted.

Next, the controller 400 controls the Z-axis drive assembly 330 to lower the stage 211 by a distance corresponding to one layer of the layered fabrication structure, and lower and position the fabrication plate 212 on the stage 211 to a position at which the layered fabrication structure of the next layer (second layer) is created (S8). Then, the controller 400 controls the X-axis drive assembly 310 and the Y-axis drive assembly 320 according to the slice data of the second layer to extrude the filaments through the nozzles 111 of the fabrication head 110 while sequentially moving the tips of the nozzles 111 to target positions. In the fabrication process, another layered fabrication structure is formed on the layered fabrication structure of the lowest layer, which has been formed on the fabrication plate 212 of the stage 211, according to the slice data of the second layer (S6).

In this way, the controller 400 repeats the process of controlling the Z-axis drive assembly 330 to laminate the layered fabrication structures in order from a lower layer while sequentially lowering the stage 211. When the creation of a layered fabrication structure of the uppermost layer has been completed (Yes in S7), the three-dimensional object according to the input three-dimensional shape data is fabricated on the fabrication plate 212.

When the fabrication process is thus terminated, the controller 400 controls the Z-axis drive assembly 330 to lower the stage 211 to a predetermined taking-out position (the lowest point in the present embodiment) (S9). The taking-out position is set to a position at which the three-dimensional object on the stage 211 can be easily taken out to the outside of the chamber 220 when the swing door 226 in the front wall 225 of the chamber 220 is opened.

Immediately after the termination of the fabrication process, the processing space in the chamber 220 is still at high temperature, and thus a user cannot open the swing door 226 and take out the three-dimensional object in the processing space soon. Therefore, after the temperature in the processing space decreases to a temperature at which the three-dimensional object can be taken out, the user opens the swing door 226 and takes out the three-dimensional object in the processing space with the three-dimensional object being adhered to the fabrication plate 212. The controller 400 preferably provides a cooling period in which the swing door 226 is in locked state until the temperature in the processing space decreases to the temperature at which the three-dimensional object can be taken out, and cancels the locked state of the swing door 226 after the temperature in the processing space decreases to the temperature at which the three-dimensional object can be taken out.

Details of Fabrication Head

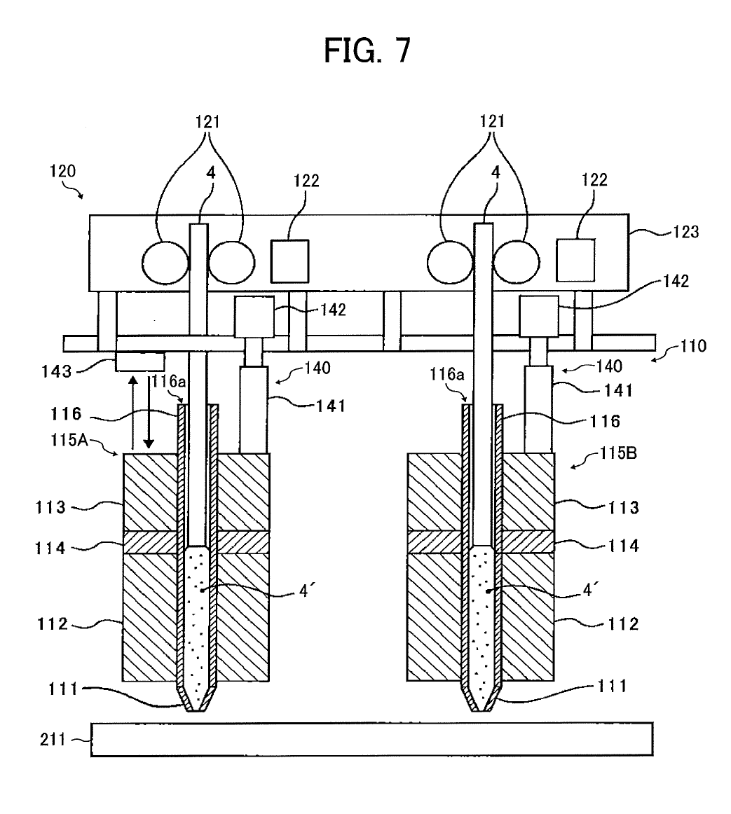

Next, the configuration and operation of fabrication head 110 are described in detail. FIG. 7 is a cross-sectional view of the configuration of fabrication head 110 in the present embodiment. In the fabrication head 110 in the present embodiment, four nozzles 111 are arranged in 2×2. Note that the four nozzles 111 are illustrated side by side in FIG. 2 for convenience of description. Each of the four nozzles 111 is covered (surrounded) by a corresponding one of the head heating portions 112, and the controller 400 can separately control each of the head heating portions 112. Such a configuration allows each of the head heating portions 112 to individually heat materials, such as the filaments 4 or the support material, for each nozzle 111.

As illustrated in FIG. 7, the head heating portion 112 is attached to a heat insulation portion 114 made of heat insulation materials. The head heating portions 112 are separated from each other. Such a configuration reduces the propagation of heat of one head heating portion 112 during heating to other head heating portions 112 to heat the filaments 4 of other nozzles 111.

The head cooling portion 113 is disposed at the side opposite to the nozzle 111 with respect to the head heating portion 112, that is, the upstream side from the head heating portion 112 in the transfer direction of the filament 4. As illustrated in FIG. 7, the head cooling portion 113 has a block shape and is made of a highly heat-conductive heat-absorbing material, such as aluminum, and is disposed corresponding to each head heating portion 112. Note that, in some embodiments, a common head cooling portion 113 may be provided for the four head heating portions 112.

A transfer conduit 116 is arranged to path through the head heating portion 112 and the head cooling portion 113. The transfer conduit 116 forms a transfer path to transfer the filament 4 to the nozzle 111. An upper end portion (an upstream end in the transfer direction of the filament 4) of the transfer conduit 116 serves as an introduction portion 116a to introduce the filament 4, and the filament 4 introduced from the introduction portion 116a is transferred to the nozzle 111 through the interior (transfer path) of the transfer conduit 116. During the transfer, the filament 4 in the transfer conduit 116 is brought into a molten state (or softened state) by the heat of the head heating portion 112, and the filament 4′ in the molten state is transferred to the nozzle 111.

Heat from the head heating portion 112 propagates not only to a filament portion of the transfer conduit 116 passing through the head heating portion 112 but also to the upstream side of the filament portion in the transfer direction. At this time, if the filament 4 is heated and melted at a position away from the head heating portion 112 on the upstream side in the transfer direction, the filament 4 would be solidified at the position when the heating process of the head heating portion 112 is stopped or interrupted. As a result, even if the heating process of the head heating portion 112 is then resumed, it would take time until the filament 4 at the position is melted again. In such a case, the filament 4 supplied from the filament supply unit 120 would not be transferred in fabrication head 110, thus causing clogging. Therefore, the heating range of the filament 4 by the head heating portion 112 is preferably configured not to spread as far as possible toward the upstream side in the transfer direction of the filament 4, so that adhered filament can be promptly remelted after the heating process of the head heating portion 112 is resumed.

Hence, in the present embodiment, the head cooling portion 113 is disposed on the upstream side of the head heating portion 112 in the filament transfer direction. The heat absorbing material constituting the head cooling portion 113 is in close contact with the transfer conduit 116 through which the filament 4 passes, and the head cooling portion 113 absorbs the heat of the filament 4 in the transfer conduit 116 to cool the filament 4. Such a configuration prevents the heating range of the filament 4 by the head heating portion 112 from spreading to the upstream side in the filament transfer direction.

The filament supply unit 120 in the present embodiment is configured to be movable with the fabrication head 110 as a single unit. As illustrated in FIG. 7, the filament supply unit 120 drives an extruder 121 as a material feeder to clamp the filament 4 by a motor 122 to feed the filament 4 to the introduction portion 116a of the transfer conduit 116 of the fabrication head 110. The controller 400 controls the drive of the motor 122 to control the drive amount of the extruder 121, thus allowing control of the feeding amount and speed of the filament 4. Since the extrusion amount and speed of the filament 4′ extruded from the nozzle 111 can be controlled by controlling the feeding amount and speed of the filament 4, the controller 400 controls the drive of the extruder 121 of the filament supply unit 120 to control the extrusion amount and speed of the filament 4′ extruded from the nozzle 111.

Each of the four nozzles 111 held on the fabrication head 110 is integrally formed with the transfer conduit 116, the head heating portion 112, the head cooling portion 113, and the heat insulation portion 114 to constitute each of the nozzle units 115A to 115D. Note that, in FIG. 7, only two nozzle units 115A and 115B are illustrated. Each of the nozzle units 115A to 115D is held on a fixation block 123 of the filament supply unit 120, which supports the extruder 121, with a nozzle-unit holder 140 as a positioner.

The nozzle-unit holder 140 includes an actuator 141 as an ejector driver fixed to the fixation block 123 and a motor 142 to drive the actuator 141. Each of the nozzle units 115A to 115D is mounted to a driving end of each actuator 141. The controller 400 that controls the motor 142 controls driving of the actuator 141 to move up and down each of the nozzle units 115A to 115D attached to the driving end of each actuator 141. Therefore, through the driving of each actuator 141, the position of the nozzle 111 of each of the nozzle units 115A to 115D can be individually displaced with respect to the fixation block 123 in contact-and-separation directions in which the nozzle 111 and the stage 211 come into contact with and separate from each other.

In the fabrication process in the present embodiment, among the nozzle units 115A to 115D held on the fixation block 123, a nozzle unit including the nozzle 111 to extrude the filament 4 for use is moved to a predetermined use position by the actuator 141. On the other hand, a nozzle unit including an unused nozzle 111 except for the nozzle 111 to be used is retracted with the actuator 141 to a predetermined retracted position farther from the stage 211 than the use position. Such a configuration can prevent a situation in which the unused nozzle 111 itself or the filament hanging from the unused nozzle 111 comes into contact with the filament 4′ extruded from the nozzle 111 to be used.

Initialization Process

Next, an initialization process (position adjustment method) to adjust relative positions of the nozzle 111 and the stage 211 in the Z-axis direction is described below. Below, descriptions are given using only two nozzle units 115A and 115B for simplicity of explanation.

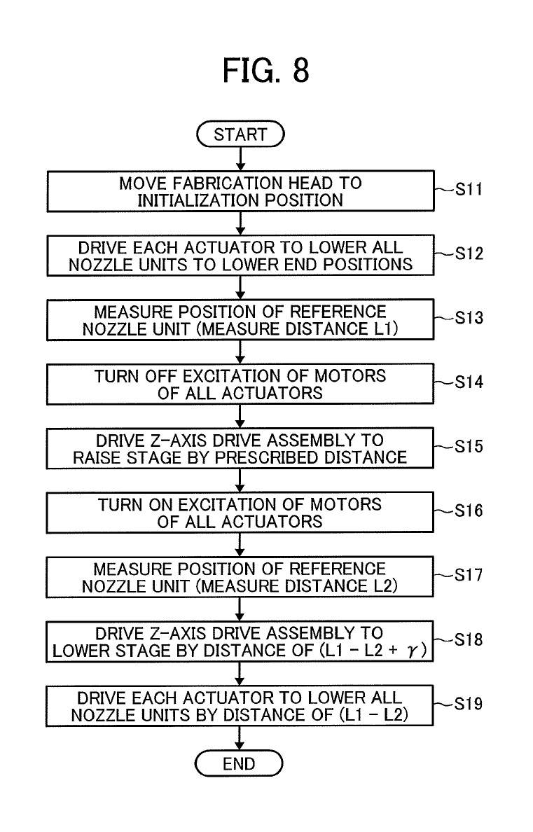

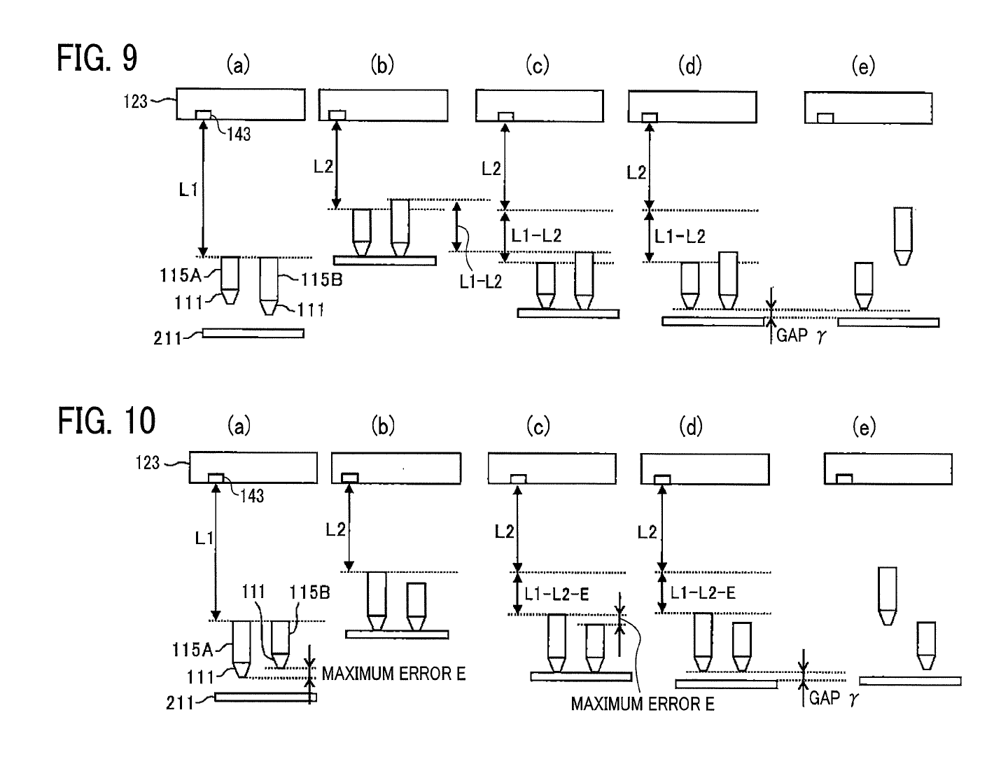

FIG. 8 is a flowchart of a flow of Initialization process according to the present embodiment. FIGS. 9A to 9E are illustrations of the positions of the nozzle units 115A and 115B and the stage 211 in the Z-axis direction at time points during initialization process. In the present embodiment, a distance measuring sensor 143 as an ejector position detector to detect the position in the Z-axis direction of the first nozzle unit 115A serving as a reference is mounted to the fixation block 123 of the filament supply unit 120 supporting the extruder 121. The distance measuring sensor 143 is not particularly limited as long as the distance measuring sensor 143 can measure the distance in the Z-axis direction (Z-axis direction distance) between a reference point on the fixation block 123 (a lower surface of the fixation block 123) and a measured point on the first nozzle unit 115A (for example, an upper surface of the head cooling portion 113). The Z-axis direction distance measured by the distance measuring sensor 143 indicates the position of the reference first nozzle unit 115A with respect to the fixation block 123 in the Z-axis direction.

The initialization process in the present embodiment is performed at a predetermined timing, which can be arbitrarily set, such as, upon power-on of the three-dimensional fabricating apparatus 1, before starting the preheating process in response to, e.g., an instructing operation of a user, before starting the fabrication process after the preheating process, when the number of times of fabrication of three-dimensional objects has reached a specified number of times. However, in the present embodiment, the fabrication process is performed in a state in which the inside of the chamber 220 accommodating the nozzles 111 and the stage 211, which are targets of the relative position adjustment, is set to a high temperature. Therefore, considering, e.g., thermal expansion, the initialization process is preferably performed when the internal temperature of the chamber 220 is raised to a temperature for the fabrication process or its vicinity.

In the initialization process in the present embodiment, first, the controller 400 controls the X-axis drive assembly 310 and the Y-axis drive assembly 320 to move the fabrication head 110 to a predetermined initialization position (S11). The initialization position is a position on the X-Y plane opposed to a predetermined point on the stage 211 or the fabrication plate 212, and is, for example, a center position of the stage 211 or the fabrication plate 212. In consideration of eliminating an error of the fabrication plate 212, it is preferable to set the initialization position at a position opposed to a predetermined point on the fabrication plate 212 with fabrication plate 212 set on the stage 211. On the other hand, unless the error of fabrication plate 212 is taken into consideration, the initialization position may be set at a position opposed to a predetermined point on the stage 211. Alternatively, for a member (a member included in the stage 211) that is integrally formed with the stage 211, the initialization position may be set at a position opposed to a predetermined point on the member. Hereinafter, an example in which the initialization position is set at a position opposed to a predetermined point on the stage 211 is described below.

After moving fabrication head 110 to the predetermined initialization position, the controller 400 drives the actuators 141 to lower the nozzle units 115A and 115B on fabrication head 110 to the lower end positions (S12). At this time, the excitation of the motor 122, which is a stepping motor to drive the extruder 121 to feed the filament 4, is off. Accordingly, even when the filament 4 is pulled downward as the nozzle units 115A and 115B descend, the extruder 121 is driven to rotate with the descending of the nozzle units 115A and 115B to smoothly send the filament 4.

Based on measurement results of the distance measuring sensor 143, the controller 400 acquires a Z-axis direction distance L1 between the fixation block 123 and the reference first nozzle unit 115A (S13). In the present embodiment, the nozzle units 115A and 115B are made to be displaceable in the Z-axis direction with respect to the fabrication head 110. Specifically, in the present embodiment, since the stepping motor is used as the motor 142 of the actuator 141 to drive the nozzle units 115A and 115B, the excitation of the motor 142 is turned off (S14). As a result, the nozzle units 115A and 115B receive an external force and turn into a state in which the nozzle units 115A and 115B are displaceable in a driving direction of the actuator 141, that is, the Z-axis direction. Note that, in the present embodiment, the method of turning off the excitation of the motor 142 is employed as the method of turning the nozzle units 115A and 115B into a state in which the nozzle unit 115A and the nozzle unit 115B are displaceable in the Z-axis direction with respect to the fabrication head 110.

After turning off the excitation of all the motors 142 in this way, the controller 400 drives the Z-axis drive assembly 330 as a relative moving assembly to raise the stage 211 by a prescribed distance as illustrated in (b) of FIG. 9 (S15). Taking various errors into consideration, the prescribed distance is set a distance at which, even if the stage 211 contacts and pushes up all the nozzle units 115A and 115B located at the lower end, the stage 211 would not push up the nozzle units 115A and 115B to upper end positions at which all the nozzle units 115A and 115B are displaceable. As a result, all the nozzle units 115A and 115B can be brought into contact with the stage 211. After starting the ascending of the stage 211, based on measurement results of the distance measuring sensor 143, the controller 400 may drive the Z-axis drive assembly 330 to raise the stage 211 by a prescribed distance (prescribed time) from a detection of a change on the position of the reference first nozzle unit 115A in the Z-axis direction.

Alternatively, the first nozzle unit 115A, which measures the distance in advance by the distance measuring sensor 143, may be disposed at a position slightly higher than the other nozzle unit 115B. In such a case, on detection of a change in the Z-axis direction position of the reference first nozzle unit 115A, the controller 400 determines that all the nozzle units 115A and 115B are in contact with the stage 211. Such a configuration can reduce an elevation distance (L1-L2 in FIG. 9) of the nozzle unit, thus reducing an error of the movement distance due to the ascending and descending of the nozzle unit.

Here, in the present embodiment, when the stage 211 contacts the nozzle units 115A and 115B, the nozzle units 115A and 115B in a displaceable state displaces, thus releasing the force applied to the nozzle units 115A and 115B. Accordingly, the force applied to the nozzle units 115A and 115B and the stage 211 at the time of contacting is reduced as compared with the case in which the nozzle units 115A and 115B are in secured state (non-displaceable state), thus reducing damage to the nozzle units 115A and 115B.

Next, in the above-described state in which the stage 211 is in contact with the nozzle units 115A and 115B, the controller 400 positions the nozzle units 115A and 115B with respect to the fabrication head 110. For example, in the present embodiment, the excitation of the motor 142 of the actuator 141 to drive the nozzle units 115A and 115B is turned on (S16). Based on measurement results of the distance measuring sensor 143, as illustrated in (b) of FIG. 9, the controller 400 acquires a Z-axis direction distance L2 between the fixation block 123 and the reference first nozzle unit 115A (S17).

The Z-axis direction distance L2 acquired at this time indicates the Z-axis direction position of each of the stage 211 and the nozzle units 115A and 115B in a state in which the stage 211 is in contact with each of the nozzle units 115A and 115B. Accordingly, the Z-axis direction distance L2 is a distance in a state in which there is no error with respect to the relative positions between the stage 211 and each of the nozzle units 115A and 115B, and can be used as a reference to adjust the relative positions between the stage 211 and each of the nozzle units 115A and 115B.

Then, the controller 400 drives the Z-axis drive assembly 330 to lower the stage 211 by a distance (L1-L2+γ)(S18) and drives the motor 142 of each actuator 141 to lower all the nozzle units 115A and 115B by the distance (L1-L2) (S19). In the present embodiment, a position lower than the position (reference position) of the distance L2 by the distance (L1-L2) is set to the use position of the nozzles 111 of each of the nozzle units 115A and 115B. Therefore, by lowering all the nozzle units 115A and 115B from the position (reference position) of the distance L2 by the distance (L1-L2), as illustrated in (c) of FIG. 9, all of the nozzle units 115A and 115B are positioned at the use positions.

On the other hand, the stage 211 is lowered from the position (reference position) of the distance L2 by a distance (L1-L2+γ), which is obtained by adding a target gap amount (a target separation distance between the stage 211 and the nozzle 111 of each of the nozzle units 115A and 115B)₇ to the distance (L1-L2). Accordingly, as illustrated in (d) of FIG. 9, the stage 211 is positioned at a position lower by the target gap amount than all the nozzle units 115A and 115B positioned at the use positions. The position is the Z-axis direction position of the stage 211 at the time of starting the layered structure of the first layer by the filament 4′ extruded from the nozzles 111 of the nozzle units 115A and 115B positioned at the use positions.

When the fabrication process is performed, as illustrated in (e) of FIG. 9, the controller 400 controls the actuator 141 to raise the second nozzle unit 115B, which is not to be used, from the use position to the retracted position with the first nozzle unit 115A to be used placed at the use position. In the present embodiment, the retracted position is substantially the same as the reference position (the position of the distance L2) illustrated in (b) of FIG. 9. However, the retracted position is not particularly limited as long as, at the position, the nozzle 111 of the second nozzle unit 115B not to be used or a filament hanging from the second nozzle unit 115B can be prevented from contacting the filament 4′ extruded from the nozzle 111 of the first nozzle unit 115A to be used.

Furthermore, when the nozzle unit to be used is switched to the second nozzle unit 115B, the actuator 141 of the second nozzle unit 115B is controlled to descend by a distance raised when the second nozzle unit 115B is not in use, to place the second nozzle unit 115B at the reference position. At this time, the controller 400 controls the actuator 141 to raise the first nozzle unit 115A, which is not used, from the use position to the retracted position, thus preventing the nozzle 111 of the unused first nozzle unit 115A or the filament hanging from the nozzle 111 of the first nozzle unit 115A from contacting the filament 4′ having been already extruded.

According to the initialization process in the present embodiment, with reference to the state (the position of the distance L2) in which there is no error in the relative positions with the stage 211 and each of the nozzle units 115A and 115B contacting each other, each of the nozzle units 115A and 115B is positioned at the use position and the stage 211 is positioned at a position at which the layered structure of the first layer is started. The accuracy of the relative positions between the stage 211 and each of the nozzle units 115A and 115B is high, and the gap amount (separation distance) between each of the nozzle units 115A and 115B at the use position and the stage 211 at the start position of the layered structure of the first layer can be accurately adjusted to the target gap amount γ. Since the movement amount of the stage 211 can be controlled at high accuracy with the Z-axis drive assembly 330, the gap amount of the second and subsequent layers can also be adjusted at high accuracy.

Particularly, when a three-dimensional object is fabricated according to fused deposition modeling (FDM) as in the present embodiment, the gap amount (particularly, the first layer) between the nozzle 111 to extrude the filament 4′ and the fabrication plate 212 on the stage 211 is preferably adjusted at higher accuracy. If the gap amount is too large, the pressing force for pressing the filament 4′ extruded from the nozzle 111 against the fabrication plate 212 or the layered structure of a lower layer would be weak, thus causing a failure, such as a sufficient adhesive force between the extruded filament 4′ and one of the fabrication plate 212 and the layered structure of the lower layer. By contrast, if the gap amount is too small, the extrusion resistance at the time of extruding the filament 4′ from the nozzle 111 would increase, thus causing a failure, such as clogging of filament. According to the present embodiment, the gap amount can be adjusted with high accuracy, thus reducing such a failure.

In the present embodiment, as illustrated in (b) of FIG. 9, a state in which both of the nozzle units 115A and 115B are in contact with the stage 211 is set as the reference position. Therefore, as illustrated in (a) of FIG. 9, even if the tip position of the nozzle 111 is misaligned between the two nozzle units 115A and 115B before the start of the initialization process, the reference position is determined in the absence of the misalignment. Therefore, when the actuators 141 displace the nozzle units 115A and 115B afterward according to the reference position, the nozzle units 115A and 115B can be displaced in a state in which the misalignment between the nozzle units 115A and 115B has been corrected.

When the tip position of the nozzle 111 is misaligned between the two nozzle units 115A and 115B, the stage 211 cannot be brought into contact with both of the nozzle units 115A and 115B in a state in which the nozzle units 115A and 115B cannot be displaced. In the present embodiment, the stage 211 is brought into contact with the nozzle units 115A and 115B in the displaceable state, thus allowing the state in which both of the nozzle units 115A and 115B are in contact with the stage 211 to be set to the reference position.

Further, in the above description, as illustrated in (a) of FIG. 9, when all the nozzle units 115A and 115B on the fabrication head 110 are lowered to the lower end positions, the tip position of the nozzle 111 of the second nozzle unit 115B is located lower than the tip position of the nozzle 111 of the reference first nozzle unit 115A. However, as illustrated in (a) of FIG. 10, if the tip position of the nozzle 111 of the second nozzle unit 115B is located at a position higher than the tip position of the nozzle 111 of the reference first nozzle unit 115A when all the nozzle units 115A and 115B on the fabrication head 110 are lowered to the lower end positions, in the above-described initialization process, the second nozzle unit 115B might reach the lower end in the drivable range of the actuator 141 before the second nozzle unit 115B descends to the target use position. In such a case, the second nozzle unit 115B is not positioned at the target use position.

Therefore, when all the nozzle units 115A and 115B are lowered by driving the motors 142 of the respective actuators 141 (S19), the descending distance is preferably set in consideration of a maximum error E in the tip position of the nozzle 111 between the nozzle units 115A and 115B that might occur when all the nozzle units 115A and 115B are lowered to the lower end positions. For example, the descending distance at which the nozzle units 115A and 115B descend when all the nozzle units 115A and 115B are lowered by driving the motors 142 of the actuators 141 is represented by the distance (L1-L2−E) as illustrated in (c) of FIG. 10. With such a configuration, even if there is an error in the tip position of the nozzle 111 between the nozzle units 115A and 115B when all the nozzle units 115A and 115B are lowered to the lower end positions, all the nozzle units 115A and 115B can be positioned to the target use positions.

In the present embodiment, the distance measuring sensor 143 is provided only for the first nozzle unit 115A, which is one of the nozzle units 115A and 115B held on the fabrication head 110. However, in some embodiments, the distance measuring sensor 143 may be provided for each of the nozzle units 115A and 115B. In such a case, as illustrated in (b) of FIG. 9, in the state (reference position) in which both the nozzle units 115A and 115B are in contact with the stage 211, measurement results of one of distance measuring sensors 143 having a longer measurement distance may be used. With such a configuration, even if there is an error in the tip position of the nozzle 111 between the nozzle units 115A and 115B when all the nozzle units 115A and 115B are lowered to the lower end positions, all the nozzle units 115A and 115B can be positioned to the target use positions.

In the present embodiment, as illustrated in (b) of FIG. 9, the prescribed distance in raising the stage 211 is set to a distance at which the stage 211 reliably contacts and push up all the nozzle units 115A and 115B at the lower end even in consideration of various errors. However, in the configuration in which the distance measuring sensor 143 is provided for each of the nozzle units 115A and 115B, for example, the ascending of the stage 211 may be stopped when it is detected from the measurement results of both of the distance measuring sensors 143 that the nozzle units 115A and 115B are pushed up. Such a configuration can achieve more prompt initialization process.

Variation 1

Next, a description is given of one variation (hereinafter, referred to as “variation 1”) of the initialization process in the present embodiment. In the configuration in which the plurality of nozzles 111 are held on the fabrication head 110, a proper gap amount between the stage 211 and each of the nozzles 111 may be different between the nozzles 111. For example, for the nozzles 111 between which the material of the extruded filament 4 is different, an appropriate gap amount is likely to vary depending on the material. Therefore, when the proper gap amount with the stage 211 is different between the nozzles 111, the Z-axis direction positions of the nozzle units 115A and 115B are positioned at different positions according to the respective target gap amounts. In the initialization process in the present variation 1, the Z-axis direction positions of the nozzle units 115A and 115B are positioned at different positions according to the respective target gap amounts.

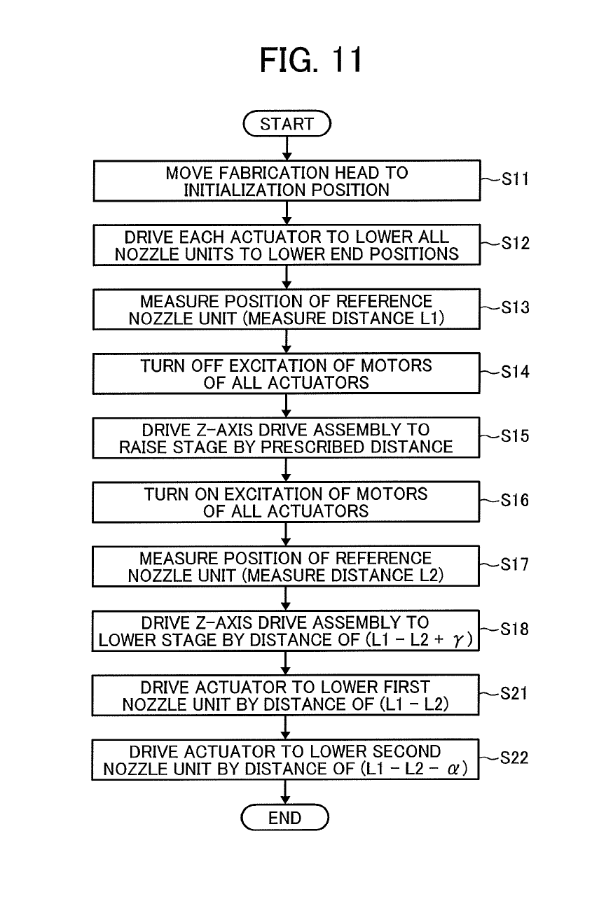

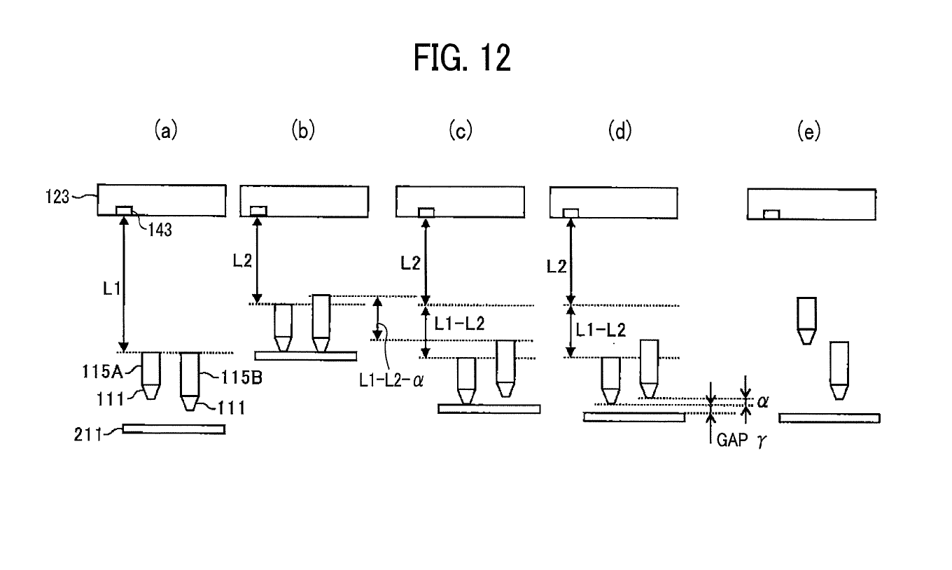

FIG. 11 is a flowchart of a flow of the initialization process according to the present variation 1. FIGS. 12A to 12E are illustrations of the positions of the nozzle units 115A and 115B and the stage 211 in the Z-axis direction at time points during initialization process in the present variation 1. Note that, in the following description, differences from the initialization processing in the above-described embodiment are mainly described.

As illustrated in (a) and (b) of FIG. 12, steps S11 to S17 in the initialization process in the present variation 1 are the same as the initialization process of the above-described embodiment. Then, in the present variation 1, the Z-axis drive assembly 330 is also driven to lower the stage 211 by the distance (L1-L2+γ) (S18). However, the descending distance is different between the nozzle units 115A and 115B.

For example, in the present variation 1, the target gap amount (γ+α) of the second nozzle unit 115B is greater by the distance α than the target gap amount γ of the first nozzle unit 115A. Accordingly, the use position of the second nozzle unit 115B is farther from the stage 211 by the distance α than the use position of the first nozzle unit 115A. Therefore, in the initialization process of the present variation 1, the motor 142 of the actuator 141 is driven to lower the first nozzle unit 115A from the position of distance L2 by the distance (L1-L2) (S21). On the other hand, the motor 142 of the actuator 141 is driven to lower the second nozzle unit 115B from the position of the distance L2 by the distance (L1-L2−α) (S22). Thus, the first nozzle unit 115A is positioned so that the gap amount between the stage 211 and the first nozzle unit 115A is the distance γ. The second nozzle unit 115B is positioned so that the gap amount between the stage 211 and the second nozzle unit 115B is the distance Or +α).

When the fabrication process is performed, as illustrated in (e) of FIG. 12, the controller 400 controls the actuator 141 to raise the first nozzle unit 115A, which is not to be used, from the use position to the retracted position with the second nozzle unit 115B to be used placed at the use position.

Variation 2

Next, a description is given of another variation of the initialization process in the present embodiment (hereinafter, referred to as “variation 2”). In the above-described embodiment, the distance measuring sensor 143 mounted to the fixation block 123 on the fabrication head 110 is used as the ejector position detector to detect the Z-axis direction positions of the nozzle units 115A and 115B. In the present variation 2, the initialization process is performed without using such distance measuring sensor 143. For example, in the present variation 2, an encoder 144 as a feed amount detector detects the feed amount of the filament 4 with the extruder 121. The Z-axis direction position of the reference nozzle unit 115A is detected from the detected feed amount to perform initialization process.

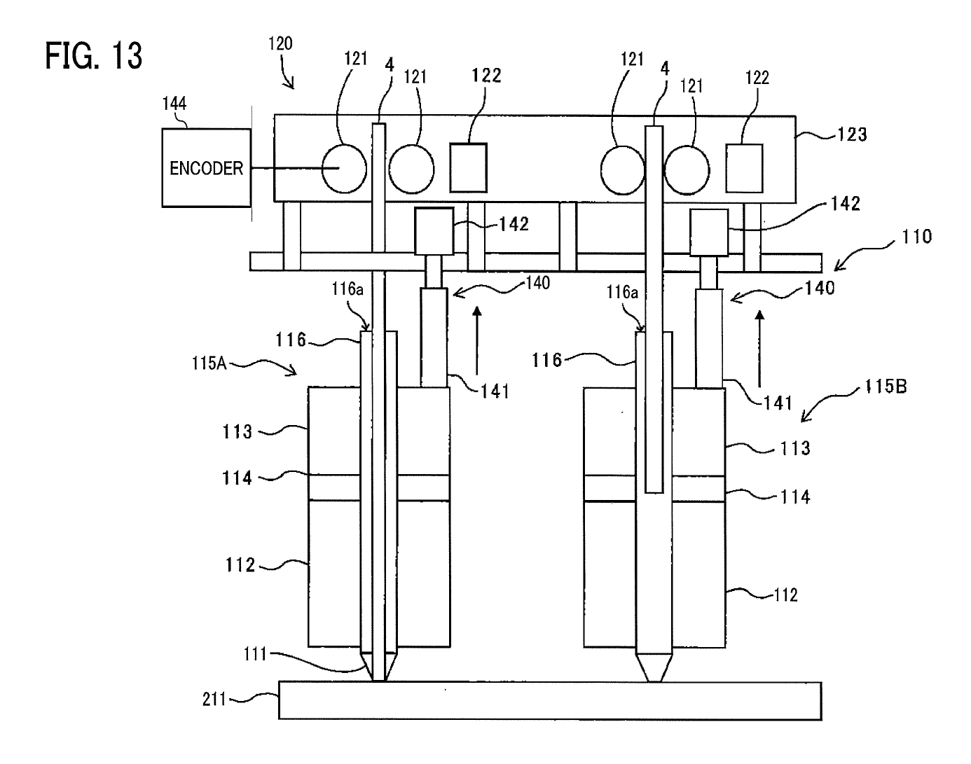

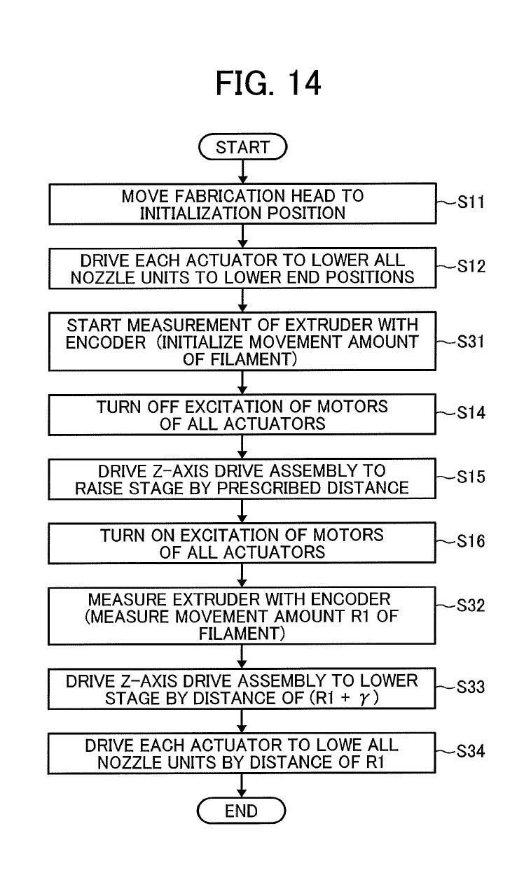

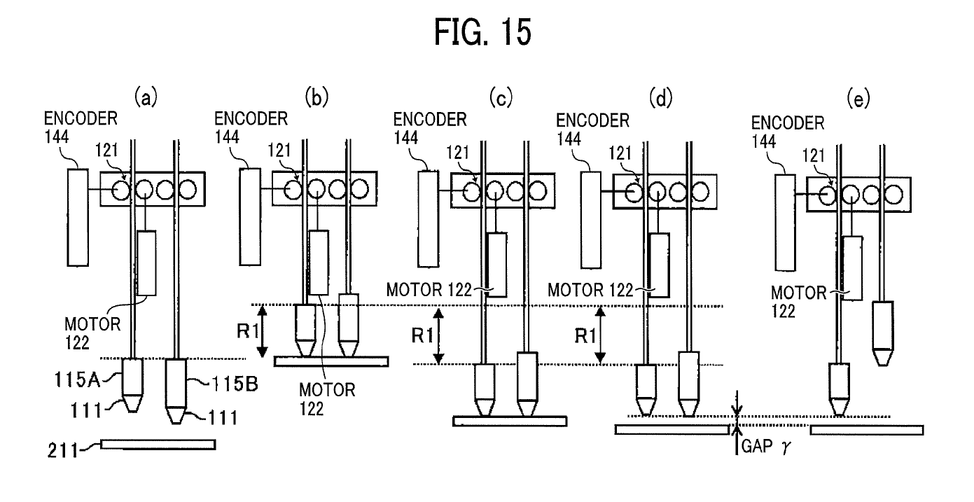

FIG. 13 is a cross-sectional view of a configuration of the fabrication head 110 in the present variation 2. FIG. 14 is a flowchart of a flow of the initialization process according to the present variation 2. FIG. 15 is an illustration of the positions of the nozzle units 115A and 115B and the stage 211 in the Z-axis direction at time points during initialization process in the present variation 2. In the initialization process in the present variation 2, like the above-described embodiment, after the fabrication head 110 is moved to the predetermined initialization position (S11), the controller 400 drives the actuators 141 to lower the nozzle units 115A and 115B on the fabrication head 110 to the lower end positions (S12) as illustrated in (a) of FIG. 15. At this time, since the excitation of the motor 122, which is a stepping motor to drive the extruder 121 to feed the filament 4, is off, the extruder 121 is driven to rotate with the descending of the nozzle units 115A and 115B, thus smoothly sending the filament 4 downward.

Then, in the present variation 2, the controller 400 starts measurement of the encoder 144 mounted to the extruder 121 (S13). The controller 400 turns off the excitation of the motors 142 of the actuators 141, which drive the nozzle units 115A and 115B, (S14) to turn the nozzle units 115A and 115B into a displaceable state in which the nozzle units 115A and 115B are displaceable in the Z-axis direction with respect to the fabrication head 110. As illustrated in (b) of FIG. 15, the stage 211 is raised by a prescribed distance (S15).

In the present variation 2, when the stage 211 during ascending contacts and pushes up the nozzle 111 of the reference first nozzle unit 115A, the filaments 4 introduced into the nozzle units 115A and 115B are also pushed up together. Accordingly, the extruder 121 is driven to rotate as the filaments 4 are pushed up, and the amount of rotation of the extruder 121 is measured with the encoder 144 (S32). The amount of rotation corresponds to an amount by which the filament 4 is pushed up, that is, an amount R1 by which the reference first nozzle unit 115A is pushed up by the ascending of the stage 211. In particular, since the first nozzle unit 115A is pushed up with the nozzle 111 being covered by the stage 211, the filament 4 does not leak out from the nozzle 111. Therefore, the driven rotation amount of the extruder 121 (the measured amount of the encoder 144) and the movement amount of the first nozzle unit 115A are highly correlated with each other, thus allowing highly-accurate measurement on the movement amount of the first nozzle unit 115A.

The position of the filament 4 when the stage 211 is raised by the prescribed distance is the same as a position of the filament 4 in a state in which the stage 211 is in contact with each of the nozzle units 115A and 115B. Accordingly, the position of the filament 4 is the position in a state in which there is no error with respect to the relative positions between the stage 211 and each of the nozzle units 115A and 115B, and can be used as a reference to adjust the relative positions between the stage 211 and each of the nozzle units 115A and 115B.

Then, the controller 400 drives the Z-axis drive assembly 330 to lower the stage 211 by a distance (R1+γ)(S33) and drives the motors 142 of the respective actuators 141 to lower all the nozzle units 115A and 115B by the distance R1 (S34). As a result, as illustrated in (c) of FIG. 15, each of the nozzle units 115A and 115B is positioned at a use position lower than the position (reference position) of the filament movement amount R1 by a distance corresponding to R1.

On the other hand, the stage 211 is lowered from the position (reference position) of the filament movement amount R1 by the distance (R1+γ), which is obtained by adding the target gap amount γ to the distance corresponding to R1. Accordingly, as illustrated in (d) of FIG. 15, the stage 211 is positioned at a position lower by the target gap amount γ than all the nozzle units 115A and 115B positioned at the use positions.

Note that the various configurations and operations described in the above-described embodiments and the above-described variations can be appropriately combined. Further, in the present embodiment, adjustment of the relative positions between the stage 211 and each of the nozzles 111 of the nozzle units 115A and 115B or the fabrication process of the three-dimensional object is realized without steps involving a manual operation of a worker or the like. However, some of the steps may be realized by a manual work of a human. For example, the step of lowering the nozzle units 115A and 115B on the fabrication head 110 to the lower end positions (S12), the step of raising the stage 211 by a prescribed distance (S15), and the like may be realized by a manual work of a human.

The present invention is not limited to the above-described fused deposition modeling (FDM) but is also applicable to a three-dimensional fabricating apparatus that fabricates a three-dimensional object according to any other fabrication method as long as the three-dimensional fabricating apparatus includes a material ejector held on a holder and a stage, which are relatively movable in contact-and-separation directions to contact and separate from each other, and fabricates a three-dimensional object on the stage with a material ejected from the material ejector.

The above-described embodiments are limited examples, and the present disclosure includes, for example, the following aspects having advantageous effects.

Aspect A

A method of producing a three-dimensional object includes a position adjustment process to adjust relative positions of a material ejector, such as the nozzle 111, held on a holder, such as the fabrication head 110, and a stage, such as the stage 211; and a fabrication process to fabricate a three-dimensional object on the stage. The fabrication process includes relatively moving the material ejector and the stage in a contact-and-separation direction (Z-axis direction) to contact and separate from each other; and forming layers of a material, such as the filament 4, ejected from the material ejector on the stage to fabricate the three-dimensional object. The position adjustment process includes a contact movement step, a positioning step, and a separation movement step. The contact movement step includes first relatively moving the holder and the stage in the contact-and-separation direction with the material ejector being held on the holder to be displaceable in the contact-and-separation direction relative to the holder, to contact the material ejector and the stage. The positioning step includes positioning the material ejector with respect to the holder in a state in which the material ejector is in contact with the stage. The separation movement step includes second relatively moving the holder and the stage in the contact-and-separation direction, with reference to positions of the holder and the stage in the contact-and-separation direction, in the state in which the material ejector is in contact with the stage so that the material ejector is away from the stage at a predetermined separation distance, such as the predetermined separation distance γ. According to the present aspect, in the contact movement step of the position adjustment process to adjust the relative positions of the material ejector and the stage, the material ejector is displaceable in the contact-and-separation direction relative to the holder. Such a configuration allows the force applied on contact of the material ejector and the stage to be released by displacement of the material ejector. In the present aspect, in the positioning step, in a state in which the material ejector and the stage are in contact with each other, the material ejector having been in the displaceable state is positioned with respect to the holder, thus adjusting the relative positions of the material ejector and the stage.

Aspect B

In the aspect A, the fabrication process includes fabricating the three-dimensional object on the stage with a material ejected from at least one material ejector of a plurality of material ejectors held on the holder. The contact movement step includes relatively moving the holder and the stage in the contact-and-separation direction to contact the plurality of material ejectors and the stage. The positioning step includes positioning the plurality of material ejectors with respect to the holder in a state in which the plurality of material ejectors are in contact with the stage. Such a configuration can simultaneously adjust the relative positions of the plurality of material ejectors and the stage held on the holder, and also correct a misalignment between the plurality of material ejectors in the contact-and-separation direction.

Aspect C

In the aspect B, the fabrication process includes driving at least another material ejector other than the at least one material ejector of the plurality of material ejectors with an ejector driver, such as the actuator 141, in fabricating the three-dimensional object, to retract the another material ejector to a retracted position at which the another material ejector is farther from the stage in the contact-and-separation direction than the at least one material ejector is. Such a configuration can stably avoid a situation in which the material ejected from the another material ejector itself or the another material ejector comes into contact with the material extruded from the at least one material ejector, thus allowing appropriate fabrication of the three-dimensional object.

Aspect D

In the aspect C, the contact movement step includes turning the ejector driver into an inoperable state, such as turning off the excitation of the motor 142, to hold the plurality of material ejectors to be displaceable in the contact-and-separation direction relative to the holder. The positioning step includes turning the ejector driver into an operable state, such as turning on the excitation of the motor 142, to position the plurality of material ejectors with respect to the holder. Such a configuration can switch a displaceable state in which the plurality of material ejectors are displaceable in the contact-and-separation direction with respect to the holder and a positioned state in which the plurality of material ejectors are positioned with respect to the holder by utilizing the ejector driver.

Aspect E

In the aspect C or D, the predetermined separation distance in the separating movement step is different between the plurality of material ejectors. The separating movement step includes driving the ejector driver so that at least one material ejector of the plurality of material ejectors is away from the stage at the predetermined separation distance. Even when the predetermined separation distance is different between the plurality of material ejectors, such a configuration can appropriately adjust the separation distance of each of the material ejectors to a corresponding one of the predetermined separation distances.

Aspect F

In any one of the aspects C to E, the separation movement step includes driving the ejector driver to displace the at least one material ejector toward the stage from a position at which the at least one material ejector is in contact with the stage; and relatively moving the holder and the stage in the contact-and-separation direction so that the at least one material ejector is away from the stage at the predetermined separation distance, such as the predetermined separation distance γ, after displacing of the at least one material ejector toward the stage. According to the present aspect, the at least one material ejector can be placed at the use position, and the stage can be placed at a position separated by a predetermined separation distance from the material ejector at the use position. Such a configuration can promptly start the fabrication process when the adjustment of the relative positions of the material ejector and the stage has been completed.

Aspect G

In the aspect F, the separation movement step includes detecting a position of the at least one material ejector in the contact-and-separation direction with an ejector position detector, such as the distance measuring sensor 143 or the encoder 144, in displacing the at least one material ejector; and controlling driving of the ejector driver based on a result of the detecting. Such a configuration allows the at least one material ejector to be appropriately placed at the use position.

Aspect H

In the aspect G, a feed amount detector, such as the encoder 144, to detect a feed amount at which a material feeder, such as the extruder 121, feeds the material to the at least one material ejector is used as the ejector position detector. Such a configuration can appropriately position the at least one material ejector at the use position by utilizing the feed amount detector.

Aspect I

A position adjustment method of adjusting relative positions of a material ejector held on a holder and a stage in a three-dimensional fabricating apparatus that relatively moves the material ejector and the stage in a contact-and-separation direction to contact and separate from each other and forms layers of a material ejected from the material ejector on the stage. The method includes a contact movement step, a positioning step, and a separation movement step. The contact movement step includes first relatively moving the holder and the stage in the contact-and-separation direction with the material ejector being held on the holder to be displaceable in the contact-and-separation direction relative to the holder, to contact the material ejector and the stage. The positioning step includes positioning the material ejector with respect to the holder in a state in which the material ejector is in contact with the stage. The separation movement step includes second relatively moving the holder and the stage in the contact-and-separation direction, with reference to positions of the holder and the stage in the contact-and-separation direction in the state in which the material ejector is in contact with the stage, so that the material ejector is away from the stage at a predetermined separation distance. According to the present aspect, in the contact movement step of the position adjustment process to adjust the relative positions of the material ejector and the stage, the material ejector is displaceable in the contact-and-separation direction relative to the holder. Such a configuration allows the force applied on contact of the material ejector and the stage to be released by displacement of the material ejector. In the present aspect, in the positioning step, in a state in which the material ejector and the stage are in contact with each other, the material ejector having been in the displaceable state is positioned with respect to the holder, thus adjusting the relative positions of the material ejector and the stage.

Aspect J

A three-dimensional fabricating apparatus relatively moves a material ejector held on a holder and a stage in a contact-and-separation direction with a moving assembly to contact and separate from each other and forms layers of a material ejected from the material ejector on the stage. The three-dimensional fabricating apparatus includes a positioner, such as the nozzle-unit holder 140, to switch a displaceable state in which the material ejector is displaceable in the contact-and-separation direction relative to the holder and a positioned state in which the material ejector is positioned relative to the holder. The three-dimensional fabricating apparatus switches the positioner to the displaceable state and relatively moves the holder and the stage in the contact-and-separation direction with the moving assembly to contact the material ejector and the stage, and switches the positioner to the positioned state in a state in which the material ejector is in contact with the stage and relatively move the holder and the stage in the contact-and-separation direction with the moving assembly so that the material ejector is away from the stage at a predetermined separation distance. According to the present aspect, in the position adjustment process to adjust the relative positions of the material ejector and the stage, the material ejector contacts the stage in the discplaceable state in which the material ejector is displaceable in the contact-and-separation direction relative to the holder. Such a configuration allows the force applied on contact of the material ejector and the stage to be released by displacement of the material ejector. In the present aspect, in the state in which the material ejector and the stage are in contact with each other, the material ejector having been in the displaceable state is positioned with respect to the holder, thus adjusting the relative positions of the material ejector and the stage.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Each of the functions of the described embodiments may be implemented by one or more processing circuits or circuitry. Processing circuit or circuitry (or control circuits or circuitry) includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A method of producing a three-dimensional object, the method comprising:
adjusting relative positions of a material ejector held on a holder and a stage;
fabricating the three-dimensional object on the stage,
the fabricating including:
relatively moving the material ejector and the stage in a contact-and-separation direction to contact and separate from each other; and
forming layers of a material ejected from the material ejector on the stage,
the adjusting including:
first relatively moving the holder and the stage in the contact-and-separation direction with the material ejector being held to be displaceable in the contact-and-separation direction relative to the holder, to contact the material ejector and the stage;
positioning the material ejector with respect to the holder in a state in which the material ejector is in contact with the stage; and
second relatively moving the holder and the stage in the contact-and-separation direction, with reference to positions of the holder and the stage in the contact-and-separation direction in the state in which the material ejector is in contact with the stage, so that the material ejector is away from the stage at a predetermined separation distance.

2. The method according to claim 1,
wherein the fabricating includes fabricating the three-dimensional object on the stage with a material ejected from at least one material ejector of a plurality of material ejectors held on the holder,
wherein the first relatively moving includes relatively moving the holder and the stage in the contact-and-separation direction to contact the plurality of material ejectors and the stage, and
wherein the positioning includes positioning the plurality of material ejectors with respect to the holder in a state in which the plurality of material ejectors are in contact with the stage.

3. The method according to claim 2,
wherein the fabricating includes driving another material ejector other than the at least one material ejector of the plurality of material ejectors with an ejector driver, to retract the another material ejector to a position at which the another material ejector is farther from the stage in the contact-and-separation direction than the at least one material ejector is.

4. The method according to claim 3,
wherein the first relatively moving includes turning the ejector driver into an inoperable state to hold the plurality of material ejectors to be displaceable in the contact-and-separation direction relative to the holder, and
wherein the positioning includes turning the ejector driver into an operable state to position the plurality of material ejectors with respect to the holder.

5. The method according to claim 3,
wherein the predetermined separation distance in the second relatively moving is different between the plurality of material ejectors, and
wherein the second relatively moving includes driving the ejector driver so that the at least one material ejector of the plurality of material ejectors is away from the stage at the predetermined separation distance.

6. The method according to claim 3,
wherein the second relatively moving includes:
driving the ejector driver to displace the at least one material ejector toward the stage from a position at which the at least one material ejector is in contact with the stage, and
relatively moving the holder and the stage in the contact-and-separation direction so that the at least one material ejector is away from the stage at the predetermined separation distance after displacing of the at least one material ejector toward the stage.

7. The method according to claim 6,
wherein the second relatively moving includes:
detecting a position of the at least one material ejector in the contact-and-separation direction with an ejector position detector in displacing the at least one material ejector; and
controlling driving of the ejector driver based on a result of the detecting.

8. The method according to claim 7,
wherein the detecting includes detecting the position of the at least one material ejector with, as the ejector position detector, a feed amount detector to detect a feed amount at which a material feeder feeds the material to the at least one material ejector.

9. A method of adjusting relative positions of a material ejector held on a holder and a stage in a three-dimensional fabricating apparatus that relatively moves the material ejector and the stage in a contact-and-separation direction to contact and separate from each other and forms layers of a material ejected from the material ejector on the stage, the method comprising:
first relatively moving the holder and the stage in the contact-and-separation direction with the material ejector being held to be displaceable in the contact-and-separation direction relative to the holder, to contact the material ejector and the stage;
positioning the material ejector with respect to the holder in a state in which the material ejector is in contact with the stage; and
second relatively moving the holder and the stage in the contact-and-separation direction, with reference to positions of the holder and the stage in the contact-and-separation direction in the state in which the material ejector is in contact with the stage, so that the material ejector is away from the stage at a predetermined separation distance.

10. A three-dimensional fabricating apparatus comprising:
a holder;
a stage;
a material ejector held on the holder, to eject a material to form layers of the material on the stage;
a moving assembly to relatively move the holder and the stage in a contact-and-separation direction to contact the material ejector and the stage
a positioner to switch a displaceable state in which the material ejector is displaceable in the contact-and-separation direction relative to the holder and a positioned state in which the material ejector is positioned relative to the holder; and
a controller to control the positioner to switch to the displaceable state and control the moving assembly to relatively move the holder and the stage in the contact-and-separation direction to contact the material ejector and the stage,
the controller to control the positioner to switch to the positioned state in a state in which the material ejector is in contact with the stage and control the moving assembly to relatively move the holder and the stage in the contact-and-separation direction so that the material ejector is away from the stage at a predetermined separation distance.
